(19) United States
(12) Patent Application Publication
(10) Pub. No.: US 2025/0162891 A1
(43) Pub. Date: May 22, 2025

(54) A SYSTEM FOR UTILIZING OIL AND GAS FIELD PRODUCED WATER AND CAPTURED CARBON DIOXIDE TO PRODUCE HIGH-VALUE PRODUCTS

(71) Applicant: SAUDI ARABIAN OIL COMPANY, Dhahran (SA)

(72) Inventors: Rehan FAROOQI, Dhahran (SA); Hasan IMRAN, Dhahran (SA)

(73) Assignee: SAUDI ARABIAN OIL COMPANY, Dhahran (SA)

(21) Appl. No.: 18/516,721

(22) Filed: Nov. 21, 2023

(51) Int. Cl. C01D 7/07; B01J 10/00; C25B 1/02; C25B 1/26; C25B 1/46; C25B 9/23; C25B 15/02; C25B 15/08; E21B 41/00

(52) U.S. Cl. CPC C01D 7/07; B01J 10/00; C25B 1/02; C25B 1/26; C25B 1/46; C25B 9/23; C25B 15/02; C25B 15/08; E21B 41/0064

(57) ABSTRACT

The present invention relates to systems and processes for utilizing produced water and captured carbon dioxide to produce high-value products. The system includes a produced water processing system, a carbon capture system, an electrolyzer, and a conversion chamber. The electrolyzer includes a first chamber, a second chamber, and a semi-permeable membrane and first electrode in the first chamber and a second electrode in the second chamber. The first chamber receives treated saturated produced water. The second chamber is operated at a second operating pressure that is less than the first operating pressure and facilitates the passage of sodium ions across the membrane. A current is applied to the electrodes such that the first electrode functions as an anode and the second electrode functions as a cathode, producing hydrogen gas and sodium hydroxide in the second chamber and chlorine gas in the first chamber. The polarity of the electrodes and the flow of reagents into the first and second chambers and the flow of products out of the first and second chambers may be reversed.

### FIELD OF THE INVENTION

The present invention generally relates to a system for utilizing oil and gas field produced water and captured industry carbon dioxide to produce high-value products. More specifically, the present invention relates to a system and method for capturing and utilizing carbon dioxide emissions generated by industrial processes to generate value added products.

### BACKGROUND

Industrial processes across various sectors, such as oil and gas industries, power generation, chemical production, and manufacturing, contribute significantly to global carbon emissions. Application of carbon capture, utilization, and sequestration is urgently needed to mitigate industrial carbon emissions given concerns about global climate change. Consequently, there has been a growing interest in developing technologies to capture and mitigate carbon dioxide emissions. The adverse effects of anthropogenic carbon dioxide emissions on the global climate have spurred significant research and development efforts aimed at reducing greenhouse gas concentrations in the atmosphere. Available approaches include post-combustion capture, pre-combustion capture, and direct air capture of carbon dioxide. However, these approaches often involve energy-intensive separation processes or costly infrastructure. It is important to evaluate the potential of carbon dioxide utilization/conversion into value-added products that are sequestering carbon dioxide emissions and become green products as opposed to conventional method of producing the same products without the use of CO₂ thus having less life cycle emissions.

RU2420345C2 discloses a method that produces hydroxide in water and mixes it with carbon dioxide gas flow in a process carried out in two separate chambers wherein one chamber is used to produce carbonate products and another chamber to produce bicarbonate products or mixtures of both. The method uses an electrolysis unit for producing hydroxide and the two chambers to mix hydroxide with gas flow including carbon dioxide to obtain carbonate and/or bicarbonate.

Existing processes do not use oil and gas field waste products such as produced water and captured carbon dioxide to efficiently produce valuable green products, and often instead the processes involve energy-intensive separation processes or require costly new infrastructure. There is a need for improved systems and methods to provide valuable green products from existing waste streams that are energy-efficient and economical.

### SUMMARY OF THE INVENTION

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method is disclosed of utilizing oil and gas field produced water and captured carbon dioxide to produce high-value products. The method includes preparing a saturated produced water from a first industrial process, wherein said saturated produced water comprises water and salt and capturing carbon dioxide form a second industrial process. The method further includes pumping the saturated produced water to a first chamber of an electrolyzer, wherein said first chamber is operated at a first operating pressure and conveying water to a second chamber of the electrolyzer. The second chamber is separated from the first chamber by a semipermeable membrane that is permeable to sodium ions but not permeable to magnesium ions and calcium ions. The second chamber is operated at a second operating pressure that is less than the first operating pressure of the first chamber and the difference between the first and second operating pressures facilitates the passage of sodium ions across the semipermeable membrane from the first chamber to the second chamber. A current is applied to a first electrode in the first chamber and a second electrode in the second chamber, whereby the first electrode functions as an anode and the second electrode functions as a cathode, thereby producing chlorine gas in the first chamber and hydrogen gas and sodium hydroxide in the second chamber. The hydrogen gas is separated from the sodium hydroxide and the sodium hydroxide conveyed to a conversion chamber with the captured carbon dioxide wherein at least a portion of the sodium hydroxide is reacted with the captured carbon dioxide to produce at least one of sodium carbonate and sodium bicarbonate.

In another embodiment, a system is disclosed for utilizing oil and gas field produced water and captured carbon dioxide to produce high-value products. The system includes an oil and gas field source of produced water saturated with salts, an industrial source of captured carbon dioxide, an electrolyzer, and a conversion chamber. The electrolyzer includes a first chamber, the first chamber being configured to be operated at a first operating pressure, a second chamber, and a semipermeable membrane between the first chamber and the second chamber. The semipermeable membrane is permeable to sodium ions but not permeable to magnesium ions and calcium ions. The first chamber includes a first liquid inlet, a first liquid outlet, a first gas outlet, and a first electrode. The second chamber includes a second liquid inlet, a second liquid product outlet, a second gas outlet, and a second electrode. The second chamber is configured to be operated at a second operating pressure that is different from the first operating pressure of the first chamber to facilitate the passage of sodium ions across the semipermeable membrane from the chamber with higher pressure to the chamber with lower pressure and applying a current to the first and second electrodes results in the production of sodium hydroxide from the sodium ions that have passed through the semipermeable membrane.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic diagram of a system for utilizing oil and gas field produced water and captured carbon dioxide to produce high-value products in accordance with embodiments of the disclosure.

FIG. 2 is a schematic diagram of an electrolyzer in accordance with embodiments of the disclosure.

### DETAILED DESCRIPTION OF THE INVENTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments of the present disclosure relate to a system for utilizing oil and gas field produced water and captured carbon dioxide to produce high-value products.

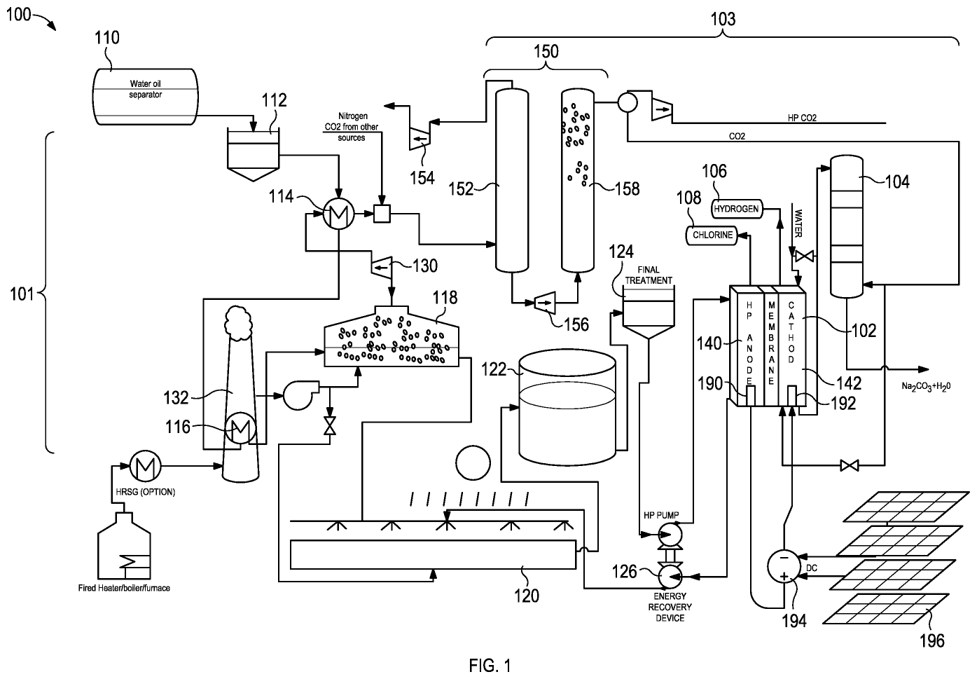

FIG. 1 is a schematic diagram of a system 100 for utilizing oil and gas field produced water and captured carbon dioxide to produce high-value products in accordance with embodiments of the disclosure. Embodiments of the system 100 include a produced water processing system 101, and a carbon capture system 103, an electrolyzer 102, a conversion chamber 104, a hydrogen gas storage system 106, and a chlorine storage tank 108.

The produced water processing system 101 processes produced water from an oil and gas field process, such as produced water from a water oil separator 110 at an oil and gas processing facility, high salinity aquifers, or reject streams from a desalination plant. Produced water from reject streams from a desalination plant may already be partially concentrated and already treated to remove impurities detrimental to the electrolyzing process and thus may be directly inserted to the process at any point including by direct injection into the electrolyzer 102.

Embodiments of the produced water processing system 101 may include a produce water pretreatment system 112, heat exchangers 114, 116, a low-pressure bubble chamber 118, an evaporation pond 120, a saturated produced water storage tank 122, a final treatment plant 124, and a pump and energy recovery system 126. The produced water pretreatment system 112 may remove chemicals from the produced water that decrease the efficiency of the process or add minerals and salts such as sodium chloride to the produced water. The produced water may be heated in heat exchangers 114, 116 that transfer heat, such as waste heat from other industrial processes such as the thermal energy from a compressor 130 or from flu gases in a stack 132 to the produced water. Heated produced water may flow through the low-pressure bubble chamber 118 before being sprayed on an evaporation pond 120, where ambient temperature, natural airflow, and continuous recycled spraying encourages evaporation of excess water content to produce a continuous outflow of saturated produced water. Some high salinity aquifers has high salinity and high temperatures up to 75 C. Water from these aquifers may be sprayed into the evaporation pond 120 to facilitate evaporation. The saturated produced water may be stored in a storage tank 122 before final treatment in a final treatment plant 124 where additional industrial salts may be added. The saturated produced water may be pumped to a chamber 140, 142 on the electrolyzer 102 having an anode electrode via a high pressure pump that may be incorporated into a pump and energy recover system 126 to improve the operating efficiency of the overall system.

Embodiments of the carbon capture system 103 may include systems for capturing carbon such as carbon dioxide from flu gases in a flu stack 132. The flu gases may pass through a heat exchanger 132 to transfer heat to the produced water before being bubbled through the low pressure bubble chamber 118. The gas may be compressed in a compressor 130 before passing through another heat exchanger 114 to transfer heat to the produced water. In embodiments, the gas may be compressed to about range from about 800 psig to about 100 psig and in other embodiments, the gas may be compressed to about 900 psig. In embodiments, carbon dioxide gas from other sources, such as other flu stacks, storage, or other industrial processes, may be conveyed into the system 100. The gas may then flow through an absorber and stripper system 150. Absorber and strippers systems 150 suitable for use in the present embodiment are known in the art. In embodiments, absorber and stripper system 150 may include a high-pressure absorbent chamber 152 that includes an absorber such as an amine or triethylene glycol. The operating pressures in the absorber and stripper system 150 may be in a range from about 700 psig to about 1,200 psig depending on the type of absorber medium in use and the composition of the gases being processed. In embodiments, a standard absorber and stripper system 150 may be modified to include a power recovery system to recover energy from the system as the gases are processed. For example, in an embodiment, the high-pressure gases in the absorber chamber 152 may be passed through a power recovery expander 154 and either be released to the atmosphere or further processed. Additionally, the absorber from the high pressure absorber chamber may pass through an energy recover device 156 where pressure is reduced to meet the requirements of the stripper 158. Portions of the carbon dioxide gas exiting the stripper 158 may be conveyed to the electrolyzer 102, the conversion chamber 104, or be stored.

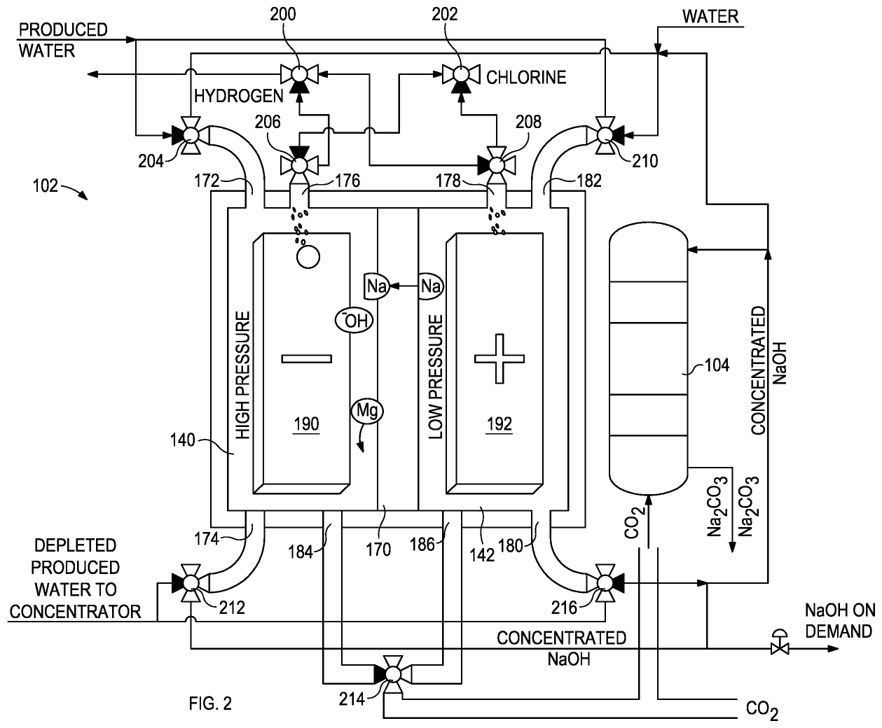

With reference to FIGS. 1 and 2, embodiments of the electrolyzer 102 may include a first chamber 140, a second chamber 142, a semipermeable membrane 170, a first liquid inlet 172, a first liquid outlet 174, a first product gas outlet 176, a second product gas outlet 178, a second liquid outlet 180, a second liquid inlet 182, a first gas inlet 184 and a second gas inlet 186. The first liquid inlet 172, the first liquid outlet 174, the first gas product outlet 176, and the first gas inlet 184 are on the first chamber 140. The second product gas outlet 178, the second liquid product outlet 180, and second liquid inlet 182, and the second gas inlet 186 are on the second chamber 142. The first chamber 140 of the electrolyzer 102 includes a first electrode 190 and the second chamber 142 includes a second electrode 192. The first and second electrodes 190, 192 are connected to a power source 194, such as a solar array 196 or other source of electricity. The semipermeable membrane 170 is between the first chamber 140 and the second chamber 142. The semipermeable membrane 170 is permeable to sodium ions (molecular weight 11) but not permeable to larger ions like chloride (molecular weight 17), magnesium (molecular weight 23) and calcium (molecular weight 40) ions. Embodiments of the semipermeable membrane allow molecules having a molecular below a threshold molecular weight to pass through the membrane, while preventing molecules having a molecular weights at or above the threshold molecular weight from passing through. In embodiments, the threshold molecular weight is about 15.

In embodiments of the system 100, the polarity of the first and second electrodes 190, 192 of the electrolyzer 102 may be reversed. When operated in the first mode, the first electrode 190 of the first chamber 140 functions as an anode and the second electrode 192 functions as a cathode. When operated in the second mode, the first electrode 190 functions as a cathode and the second electrode 192 functions as an anode.

Just as the polarity of the electrodes of the first and second chambers 140, 142 may be reversed, in embodiments the flow of material into and out of the two chambers 140, 142 of the electrolyzer 102 may be reversed. Reversing the flow of material into and out of the chambers 140, 142 may provide the benefit of unclogging the pores of the semipermeable membrane 108.

The first chamber 140 of the electrolyzer 102 may be operated under a first operating pressure and the second chamber 142 may be operated under a second operating pressure that is different from the first operating pressure. The first and second operating pressures of the first of the first and second chambers 140, 142 may also be reversed. The difference between the operating pressures of the first and second chambers 140, 142 of the electrolyzer facilitates the passage of sodium ions across the semipermeable membrane down the pressure gradient while preventing larger molecules, such as chloride, magnesium and calcium ions from crossing into the chamber 140, 142 with the cathode. The semi permeability of the semipermeable membrane 170 promotes the formation of sodium hydroxide while preventing the formation of scaling due to poorly soluble calcium hydroxide and magnesium hydroxide in the cathode chamber, which reduces the amount of pretreatment needed for the produced water. The transfer of sodium to the cathode chamber while preventing the movement of chloride ions allows for the generation of hydrogen gas and sodium hydroxide in the cathode chamber and chlorine gas in the anode chamber.

During operation of the electrolyzer 102 in a first mode, the first operating pressure in the first chamber 140 is greater than the second operating pressure in the second chamber 142. Accordingly, the pump and energy recovery system 126 pumps the treated saturated produced water into the first chamber 140 of the electrolyzer 102 at the first operating pressure. Treated saturated water enters the first chamber 140 via the first liquid inlet 172 and depleted produced water exits the first chamber 140 via the first liquid outlet 174. Water enters the second chamber 142 of the electrolyzer 102 through the second liquid inlet 182. The first electrode 190 functions as an anode and the second electrode 192 functions as an anode. Current applied to the electrodes 190, 192 results in the formation of chlorine gas in the first chamber 140 and hydrogen gas and sodium hydroxide in the second chamber 142. Chlorine gas may be conveyed to a chlorine storage tank 108 via the first gas product outlet 176 of the first chamber 140. Hydrogen gas may be conveyed to the hydrogen storage tank 106 via the second product gas outlet 178 and sodium hydroxide may be conveyed to the conversion chamber 104 by a conduit connected to the second liquid product outlet 180.

During operation of the electrolyzer 102 in the second mode, valves such as the hydrogen storage valve 200, the chlorine storage valve 202, the first liquid inlet valve 204, the first product gas outlet valve 206, the second product outlet gas valve 208, the second liquid inlet valve 210, the first liquid outlet valve 212, the first gas inlet valve 214, and the second liquid outlet valve 216 reverse the flow of reactants into and products out of the first and second chambers. For example, during the operation in the second mode, the pump and energy recovery system 126 pumps the treated saturated produced water into the second chamber 142 of the electrolyzer 102 through the second liquid inlet valve 210 and the second liquid inlet 182 and water flows into the first chamber 140 of the electrolyzer 102 through the first liquid inlet valve 204 and first liquid inlet 172. Depleted produced water and chlorine gas are produced in the second chamber 142 and hydrogen gas and sodium hydroxide are produced in the first chamber 140. Depleted produced water exits the second chamber 142 via the second liquid outlet valve and the second liquid outlet 180 and chlorine gas exits via the second product gas outlet 178 and the associated second product gas outlet valve 208. Sodium hydroxide exits the first chamber 140 via the first liquid outlet 174 and the associate first liquid outlet valve 212 and hydrogen gas exits via first product gas outlet 176 and the associated first product gas outlet valve 206. The hydrogen gas and chlorine gases are collected and stored and sodium hydroxide is conveyed to the conversion chamber 104.

In embodiments, the operation of one or more of the valves 200, 202, 204, 206, 208, 210, 212, 214, 216 may be controlled by a controller to thereby control the flow of materials into and out of the electrolyzer 102 during operation in the first and second modes.

During operation of the electrolyzer 102 in the first mode, the first operating pressure in the first chamber 140 is greater than the second operating pressure in the second chamber 142 such that sodium ions in the produced water in the first chamber 140 flow across the semipermeable membrane 170 into the second chamber 142. During operation of the electrolyzer 102 in the second mode, the second operating pressure of the second chamber 142 is greater than the first operating pressure of the first chamber 140 such that sodium ions in the produced water in the second chamber 142 flow across the semipermeable membrane 170 into the first chamber 140. In embodiments, the chamber having higher pressure may have an operating pressure in a range from about 500 psig to 900 psig while the chamber having the lower pressure may have an operating pressure in a range from about 200 psig to about 300 psig. The pressure differential between two chambers may depend on the mechanical design of the membrane support. In embodiments, the difference between the first and second operating pressures may be at least about 300 psig and in other embodiments, the pressure differential may be at least 400 psig, to facilitate any meaningful ion transfer.

During the process of switching between the first and second modes of operation, the flow of reagents into the first and second chambers (e.g., produced water and carbon dioxide) and the flow of reactants out of the chamber (e.g., depleted water, sodium hydroxide, sodium carbonate, sodium bicarbonate, hydrogen gas and chlorine gas) is stopped and reversed and the reversed flow is allowed to proceed for a duration sufficient to clear the chambers 140, 142 of chlorine and hydrogen gas before applying the reversed polarity charge to the first and second electrodes 190, 192. The delay in applying the reversed polarity charge to the first and second electrodes 190, 192 may also flush out membrane clogging larger molecules from the previously high pressure side of the semipermeable membrane 170. The flush time may depend on the contained volume, pressure difference, and membrane characteristics including surface area. In embodiments, the target duration for flushing out the membrane is less than 3% of the electrolysis time to maintain a high system efficiency.

Embodiments of the electrolyzer 102 may be utilized to produce hydrochloric acid or hypochlorous acid instead of separating the hydrogen and chloride gas streams, which reduces the need to handle gaseous chlorine.

Embodiments of the electrolyzer 102 may use partial direct injection of carbon dioxide into the chamber with the cathode electrode. When operating in the first mode, carbon dioxide may be injected into the second chamber 142 via the second gas inlet 186 and when operated in the second mode, carbon dioxide may be injected into the first chamber 140 via the first gas inlet 184. Carbon dioxide may be injected into the respective chamber of the electrolyzer 102 in a manner to prevent unused carbon dioxide from missing with the generated hydrogen gas. The carbon dioxide may be injected with nozzles directed to create turbulence to dislodge hydrogen bubbles from the surface of the cathode without increasing the concentration of carbon dioxide in the collected hydrogen gas. Some carbon dioxide may react with sodium hydroxide in the cathode chamber to produce sodium carbonate, sodium bicarbonate, or mixtures thereof.

Unreacted sodium hydroxide may be conveyed to the conversion chamber 104 where the reaction with carbon dioxide reaction will be completed thereby increasing the purity of sodium carbonate. In embodiments, the direction of flow of sodium hydroxide through the conversion chamber 104 is countercurrent to the direction of flow of the captured carbon dioxide carbon dioxide. The sodium hydroxide reacts with the carbon dioxide to generate at least one of sodium carbonate and sodium bicarbonate. The reaction between sodium hydroxide and carbon dioxide in the conversion chamber is very fast and exothermic and occurs at all temperatures and pressures. However, the concentration of carbon dioxide needs to be below the stoichiometric limit or sodium bicarbonate is immediately formed. In embodiments, the concentration of carbon dioxide is carefully controlled to maintain stoichiometric balance with sodium hydroxide flowing into the conversion chamber.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1-20. (canceled)

21. A method of utilizing oil and gas field produced water and captured carbon dioxide to produce high-value products, the method comprising:
preparing a saturated produced water from a first industrial process, wherein said saturated produced water comprises water and salt;
capturing carbon dioxide form a second industrial process;
pumping the saturated produced water to a first chamber of an electrolyzer, wherein said first chamber is operated at a first operating pressure;
conveying water to a second chamber of the electrolyzer, wherein the second chamber is separated from the first chamber by a semipermeable membrane that is permeable to sodium ions but not permeable to magnesium ions and calcium ions and further wherein said second chamber is operated at a second operating pressure that is less than the first operating pressure of the first chamber and the difference between the first and second operating pressures facilitates the passage of sodium ions across the semipermeable membrane from the first chamber to the second chamber;
applying a current to a first electrode in the first chamber and a second electrode in the second chamber, whereby the first electrode functions as an anode and the second electrode functions as a cathode, thereby producing chlorine gas in the first chamber and hydrogen gas and sodium hydroxide in the second chamber;
separating the hydrogen gas from the sodium hydroxide and conveying the sodium hydroxide to a conversion chamber;
conveying captured carbon dioxide to the conversion chamber and reacting at least a portion of the sodium hydroxide with the captured carbon dioxide in the conversion chamber to produce at least one of sodium carbonate and sodium bicarbonate.

22. The method of claim 21 wherein the first industrial process is selected from the group consisting of a water oil separator at an oil and gas facility, a high salinity aquifer, a desalination plant, and combinations thereof.

23. The method of claim 21 wherein preparing the saturated produced water includes heating the produced water, spraying the heated water over an evaporation pond and evaporating water from the heated produced water to result in saturated produced water.

24. The method of claim 21, wherein, the carbon dioxide is separated from flue gases obtained from boilers, furnaces, fired heaters, and another carbon fuel-based industrial machines.

25. The method of claim 21, further comprising injecting carbon dioxide into the second chamber to disrupt hydrogen bubble formation on the second electrode.

26. The method of claim 21, wherein difference between the first operating pressure and the second operating pressure is at least about 300 psig.

27. The method of claim 21, wherein the sodium hydroxide encounters the captured carbon dioxide in a countercurrent flow in the conversion chamber.

28. The method of claim 21 further comprising:
stopping the pumping of saturated produce water to the first chamber and stopping the conveying of water into the second chamber before pumping the saturated produce water to the second chamber at the first operating pressure and conveying water to the first chamber at the second operating pressure, wherein the first operating pressure is greater than the second operating pressure for a duration sufficient remove molecules from clogging the pores of the semipermeable membrane in the first chamber and remove chlorine gas from the first chamber and remove hydrogen gas from the second chamber; and
applying a current to the first and second electrodes of the electrolyzer whereby the second electrode functions as an anode and the first electrode functions as a cathode, thereby producing hydrogen gas and sodium hydroxide in the first chamber and chlorine gas in the second chamber;
separating the hydrogen gas from the sodium hydroxide and conveying the at least one of sodium hydroxide, sodium carbonate, and sodium bicarbonate to the conversion chamber;
reacting at least a portion of the sodium hydroxide with carbon dioxide in the conversion chamber to produce at least one of sodium carbonate and sodium bicarbonate.

29. A system for utilizing oil and gas field produced water and captured carbon dioxide to produce high-value products, the system comprising:
an oil and gas field source of produced water saturated with salts;
an industrial source of captured carbon dioxide;
an electrolyzer; and
a conversion chamber;
wherein the electrolyzer includes:
a first chamber, the first chamber being configured to be operated at a first operating pressure;
a second chamber; and
a semipermeable membrane, the semipermeable membrane being placed between the first chamber and the second chamber, the semipermeable membrane being permeable to sodium ions but not permeable to magnesium ions and calcium ions;
wherein the first chamber includes a first liquid inlet, a first liquid outlet, a first gas outlet, and a first electrode;
wherein the second chamber includes a second liquid inlet, a second liquid product outlet, a second gas outlet, and a second electrode; and
wherein the second chamber is configured to be operated at a second operating pressure that is different from the first operating pressure of the first chamber to facilitate the passage of sodium ions across the semipermeable membrane from the chamber with higher pressure to the chamber with lower pressure and further wherein applying a current to the first and second electrodes results in the production of sodium hydroxide from the sodium ions that have passed through the semipermeable membrane.

30. The system of claim 29 further comprising a produced water processing system, wherein the produced water processing system includes:
an oil and gas field source of produced water and at least one of a produced water pretreatment system, a heat exchanger, a low pressure bubble chamber, an evaporation pond, a saturated produced water tank, and a final treatment plant,
wherein the at least one of the produced water pretreatment system, the heat exchanger, the low pressure bubble chamber, the evaporation pond, the saturated produced water tank, and the final treatment plant provide the oil and gas field source of produced water saturated with salts.

31. The system of claim 30, wherein the oil and gas field source of produced water is selected from the group consisting of a water oil separator at an oil and gas facility, a high salinity aquifer, a desalination plant, and combinations thereof.

32. The system of claim 29 further comprising a carbon capture system, wherein the carbon capture system includes:
an industrial source of carbon dioxide, and at least one of a heat exchanger, a low pressure bubble system, a compressor, an absorber, and a stripper, wherein the at least one of the heat exchanger, the low pressure bubble system, the compressor, the absorber, and the stripper function to provide the industrial source of captured carbon dioxide.

33. The system of claim 32, wherein the industrial source of carbon dioxide is selected from the group consisting of a fired heater, a boiler, a furnace, and combinations thereof.

34. The system of claim 29 further comprising a pump configure to pump the produced water saturated with salts to one of the first chamber through the first liquid inlet or the second chamber through the second liquid inlet at an operating pressure to facilitate the passage of sodium ions across the semipermeable membrane.

35. The system of claim 29 wherein, the conversion chamber is configured to receive sodium hydroxide from the electrolyzer and the captured carbon dioxide and wherein the direction of flow of sodium hydroxide through the conversion chamber is countercurrent to the direction of flow of the captured carbon dioxide to result in the sodium hydroxide reacting with the carbon dioxide to produce at least one of sodium carbonate, sodium bicarbonate, and combinations thereof.

36. The system of claim 29, wherein the applying a current to the first and second electrodes results in the formation of hydrogen gas in the chamber with lower operating pressure and chlorine gas in the chamber with higher operating pressure.

37. The system of claim 36 further comprising a chlorine gas storage tank for storing the chlorine gas and a hydrogen gas storage system for storing the hydrogen gas.

38. The system of claim 29, wherein the first liquid inlet is selectively coupled to the oil and gas field source of produced water saturated with salts and a source of water by a first liquid inlet valve, and
the second liquid inlet is selectively coupled to the oil and gas field source of produced water saturated with salts and a source of water by a second liquid inlet valve, and
if the first liquid inlet valve in a position to result in the flow of produced water into the first chamber, then the second liquid inlet valve is in a position to result in the flow of water into the second chamber and if the first liquid inlet valve in a position to result in the flow of water into the first chamber, then the second liquid inlet valve is in a position to result in the flow of produced water into the second chamber.

39. The system of claim 29, wherein the first product gas outlet is selectively couple to a chlorine storage tank and a hydrogen storage system by a first product gas outlet valve, and
the second product gas outlet valve is selectively coupled to the chlorine storage tank and the hydrogen storage system by a first product gas outlet valve, and
if the first product gas outlet valve is in a position to result in the flow of chlorine gas to the chlorine gas storage tank, then the second product gas out is in a position to result in the flow of hydrogen gas to the hydrogen gas storage system, and if the first product gas outlet valve is in a position to result in the flow of hydrogen gas to the hydrogen gas storage system, then the second product gas out is in a position to result in the flow of chlorine gas to the chlorine gas storage tank.

40. The system of claim 29, further comprising a power source coupled to the first and second electrodes of the electrolyzer.

41. The system of claim 40, wherein the power source is a solar energy system.
